(19) United States
(12) Patent Application Publication
(10) Pub. No.: US 2012/0278745 A1
(43) Pub. Date: Nov. 1, 2012

(54) METHOD AND APPARATUS FOR ARRANGING ICON IN TOUCH SCREEN TERMINAL

(75) Inventors: Yong-Seok KIM, Gyeonggi-do (KR); Chul-Hwan LEE, Seoul (KR); Jong-Hyun AN, Seoul (KR)

(73) Assignee: SAMSUNG ELECTRONICS CO., LTD., Gyeonggi-Do (KR)

(21) Appl. No.: 13/451,865

(22) Filed: Apr. 20, 2012

(30) Foreign Application Priority Data
Apr. 26, 2011 (KR) 10-2011-0038950

(51) Int. Cl. G06F 3/048

(52) U.S. Cl. 715/769

(57) ABSTRACT

An apparatus and method for arranging an icon in a touch screen terminal includes selecting an icon, indicating the selected icon with another pointing image, designating a position in another screen, and arranging the selected icon at the designated position.

### CLAIM OF PRIORITY

This application claims priority under 35 U.S.C. §119 to an application filed in the Korean Intellectual Property Office on Apr. 26, 2011 and assigned Serial No. 10-2011-0038950, the contents of which are incorporated herein by reference.

### BACKGROUND OF THE INVENTION

1. Field of the Invention

The present invention relates generally to a method and apparatus for arranging an icon in a touch screen terminal.

2. Description of the Related Art

Due to fast growing development in the electronic communication industries, portable terminals, such as mobile communication terminals (cellular phones), electronic notes, and personal digital assistants (PDA), are becoming necessities in modern society.

As is well known, touch screens based on Graphic User Interface (GUI) have recently been applied to portable terminals, thus contributing to a user's convenience in data entry and surfacing of web. If a user touches a text or graphic information displayed on a touch screen with his or her finger, a portable terminal detects the user selection based on a touched position of the screen for processing. The portable terminal also provides a function that allows a user to directly rearrange icons representative of different problems as desired on the screen display. According to an icon arranging function provided by a conventional portable terminal, if a user wants to rearrange a target icon to another page on a program menu screen, the user touches the target icon and drags and drops the touched target icon to a specific position of the desired page. Such a conventional method is disadvantageous in that the user needs to keep touching a target icon until the touched target icon is dragged and dropped to a specific position of a desired page.

### SUMMARY OF THE INVENTION

An object of the present invention is to substantially solve at least the above problems and/or disadvantages and to provide at least the advantages below. Accordingly, an aspect of the present invention is to provide an apparatus and method for easily arranging icons corresponding to respective programs on any portion of a program menu screen.

Another aspect of the present invention is to provide an apparatus and method for rearranging icons by additionally displaying a hand image of picking up a target icon when the target icon is selected on a program menu screen of a touch screen terminal, then move the menu screen until a desired screen is displayed to relocate the selected target icon thereto.

Another aspect of the present invention is to provide an apparatus and method for arranging icons, in which a touching to select an icon to be rearranged on a program menu screen of a touch screen terminal and a touching to designate a position at which the selected icon is to be rearranged are independently performed.

According to an aspect of the present invention, a method for arranging an icon in a touch screen terminal includes: selecting an icon and displaying another image next to the selected icon on a first menu screen; designating a position on a second menu screen; and arranging the selected icon at the designated position.

According to another aspect of the present invention, an apparatus for arranging an icon in a touch screen terminal includes: a touch screen unit and a control unit for controlling selecting a target icon, displaying an additional image next to the selected target icon, designating a target position where the selected icon is to be rearranged, and placing the selected icon at the designated position.

### BRIEF DESCRIPTION OF THE DRAWINGS

The above features and advantages of the present invention will become more apparent from the following detailed description when taken in conjunction with the accompanying drawings in which:

FIG. 1 is a block diagram of a touch screen terminal according to an exemplary embodiment of the present invention;

FIG. 2 is a flow chart illustrating a method for arranging an icon according to an exemplary embodiment of the present invention;

FIGS. 3A to 3H illustrate a process of arranging an icon in a touch screen terminal according to an exemplary embodiment of the present invention;

FIGS. 4A to 4H illustrate a process of arranging an icon in a touch screen terminal according to another exemplary embodiment of the present invention;

FIGS. 5A to 5C illustrate a process of moving a selected icon to be rearranged, upon page switching, according to an exemplary embodiment of the present invention;

FIGS. 6A and 6B illustrate a process of moving an icon on a corresponding page in a touch screen terminal according to an exemplary embodiment of the present invention;

FIGS. 7A to 7C illustrate a process of arranging an icon on a corresponding page in a touch screen terminal according to an exemplary embodiment of the present invention; and

FIGS. 8A to 8C illustrate a process of arranging an icon on a corresponding page in a touch screen terminal according to an exemplary embodiment of the present invention.

### DETAILED DESCRIPTION OF THE PREFERRED EMBODIMENTS

Hereinafter, preferred embodiments of the present invention will be described herein below with reference to the accompanying drawings. For the purposes of clarity and simplicity, detailed descriptions of well-known functions or configurations will be omitted as they would unnecessarily obscure the subject matters of the present invention. Also, the terms used herein are defined according to the functions of the present invention. Thus, the terms may vary depending on users' or operators' intentions or practices. Therefore, the terms used herein must be understood based on the descriptions made herein.

Briefly, the present invention relates to an apparatus and method for rearranging icons corresponding to respective programs on a program menu screen by a user's simple touch action. In particular, when an icon to be rearranged is selected, a touch screen terminal according to an exemplary embodiment of the present invention may arrange icons in an intuitive manner by additionally displaying a hand image of picking up the selected icon. In addition, in an apparatus and method for arranging icons in a touch screen terminal according to an exemplary embodiment, a touching to select an icon to be rearranged and a touching to designate a position at which the selected icon is to be rearranged are independently performed.

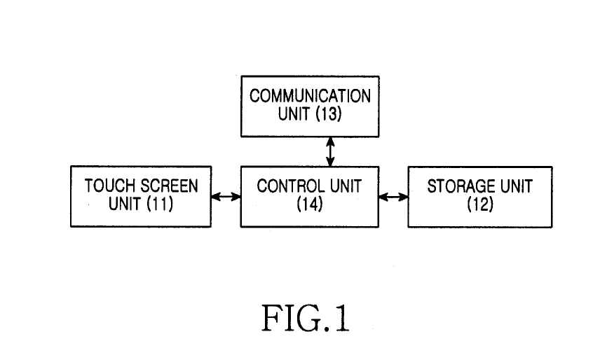

FIG. 1 is a block diagram of a touch screen terminal according to an exemplary embodiment of the present invention.

Referring to FIG. 1, a touch screen terminal according to an exemplary embodiment of the present invention includes a touch screen unit 11, a storage unit 12, a communication unit 13, and a control unit 14. The touch screen unit 11 is configured to input and output data. The storage unit 12 is configured to store data. The control unit 14 is configured to control an overall operation of the touch screen terminal.

In operation, the touch screen unit 11 outputs a touch input signal to the control unit 14, and receives and displays display data corresponding to an input signal under the control of the control unit 14. The storage unit 12 stores programs for controlling an overall operation of the touch screen terminal, and a variety of data inputted or outputted during a control operation of the touch screen terminal. The control unit 14 controls the overall operation of the touch screen terminal.

Hereinafter, an icon arranging method of the control unit 14 according to an exemplary embodiment of the present invention will be described in detail with reference to the accompanying drawings.

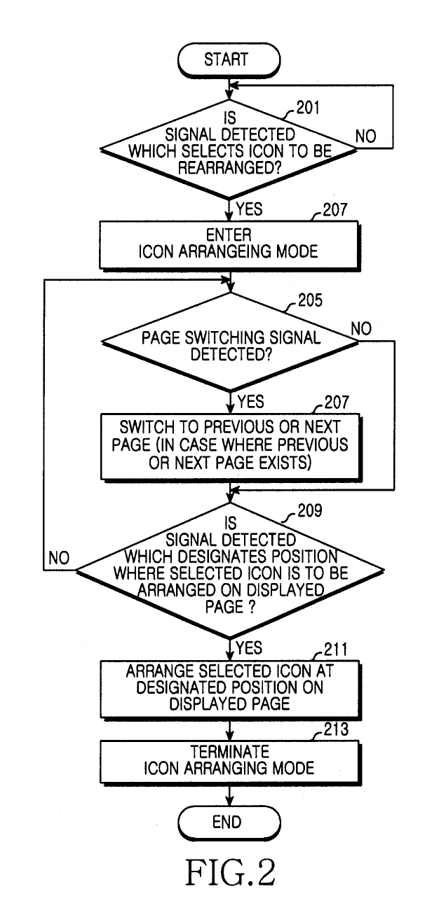

FIG. 2 is a flow chart illustrating a method for arranging an icon according to an exemplary embodiment of the present invention.

Referring to FIG. 2, the control unit 14 detects a signal selecting an icon to be rearranged in step 201, and then enters an icon arranging mode in step 203. The signal selecting the icon to be rearranged may be generated if a user keeps touching the corresponding icon for more than a critical time period. The control unit 14 highlights the selected icon during the icon arranging mode. Here, as one example, the control unit 14 may relatively highlight the selected icon by blurring regions other than a region where the selected icon is displayed. Alternatively, the control unit 14 may display the other icons in a disabled state. Since the icons displayed in the disabled state are in a state that cannot execute programs, they are displayed relatively blurrily as compared to the selected icon. Note that even though the selected icon is also in a state that cannot execute a program, it is merely highlighted as compared to the other icons. Further, the control unit 14 may additionally display a hand image of indicating or picking up the selected icon. This provides a visual effect as if the icon to be rearranged is picked up with a hand, thereby giving interest and intimacy to a user.

Thereafter, the control unit 14 detects a page switching signal in step 205 and switches a current page to a previous or next page in step 207. The page switching signal may be generated by a touch flicking motion. The touch flicking refers to a gesture that hits a touch screen with a light quick blow. In general, if a left-to-right touch flicking signal is detected, the control unit 14 switches a current page to a right (next) page. If a right-to-left touch flicking signal is detected, the control unit 14 switches a current page to a left (previous) page. If the previous or next page does not exist, the control page 14 ignores the page switching signal and displays the current page without performing the page switching. In addition, if no page switching signal is detected, the control unit 14 simply displays the current page. In sum, if a user wants to rearrange the selected icon to another page, it is necessary to switch to a desired page.

When switching a page, the control unit 14 may move the selected icon to the switched page and display the selected icon thereon. As one example, the control unit 14 may switch a page alone while the selected icon is being displayed on a screen. In some cases, the selected icon may be displayed to overlap with other icon existing on the switched page. Furthermore, the control unit 14 may switch a page by an action of picking up and handing over the selected icon. The control unit 14 may display icons existing on the switched page in a disabled state and highlight the selected icon moved to the switched page.

In step 209, the control unit 14 determines whether a signal designating a position where the selected icon is to be arranged on the displayed page is detected. If the signal is not detected, the control unit 14 returns to step 205. On the other hand, if the signal is detected, the control unit 14 arranges the selected icon at the designated position on the displayed page in step 211. Thereafter, the control signal 14 terminates the icon arranging mode in step 215. If the icon arranging mode is terminated, the control unit 14 recovers the highlighted selected icon and redisplays the other icons in an enabled state. The signal may be generated if a user keeps touching the icon at the corresponding position for more than a critical time period.

If the user wants to rearrange the selected icon to other page, the user needs to first switch a current page to a desired page. The user may move the selected icon on the displayed page and then determine a final position. For example, if the user touches a specific position on the switched page, the selected icon is moved to and displayed at the touched position, but the arrangement of the selected icon is not completed. If the user touches the selected icon displayed at the specific position or presses a home button, the arrangement of the selected icon is completed.

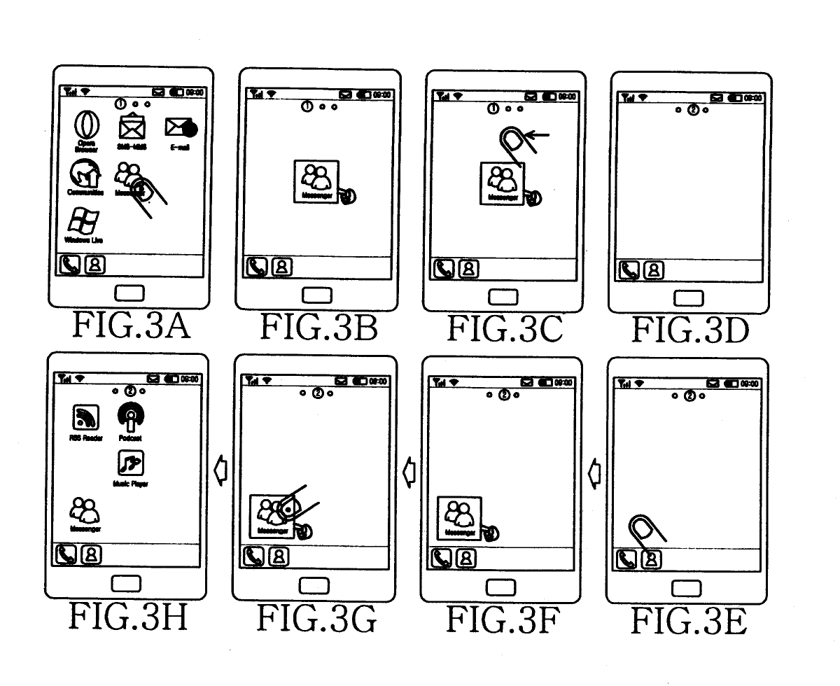

FIGS. 3A to 3H illustrate a process of arranging an icon in a touch screen terminal according to an exemplary embodiment of the present invention.

Referring to FIG. 3A, a user touches an icon to be rearranged among icons existing on a current page for more than a critical time period. Referring to FIG. 3B, the selected icon to be rearranged is highlighted, and the other icons are displayed according to a disabled state, where unselected icons is not shown or may be shown in different shade or color. In addition, the selected icon is highlighted by adding a hand image or other image thereto. To be specific, an index finger image is additionally displayed on the selected icon. Referring to FIG. 3C, if the user wants to rearrange the selected icon to a next page, the user performs the touch flicking to a desired direction. Referring to FIG. 3D, the page is switched in response to the touch flicking In this case, icons existing on the switched page are displayed according to a disabled state. Referring to FIGS. 3E and 3F, if the user touches a specific position on the switched page, the selected icon is displayed at the touched position. Further, the user may newly determine another target position while moving the selected icon to the newly desired location on the switched page. Referring to FIG. 3G, if the user touches the selected icon or presses the home button 30 after finishing moving the selected icon, the rearrangement of the selected icon is completed, the added hand image is removed, and then the other icons are redisplayed according to an enabled state, as shown in FIG. 3H.

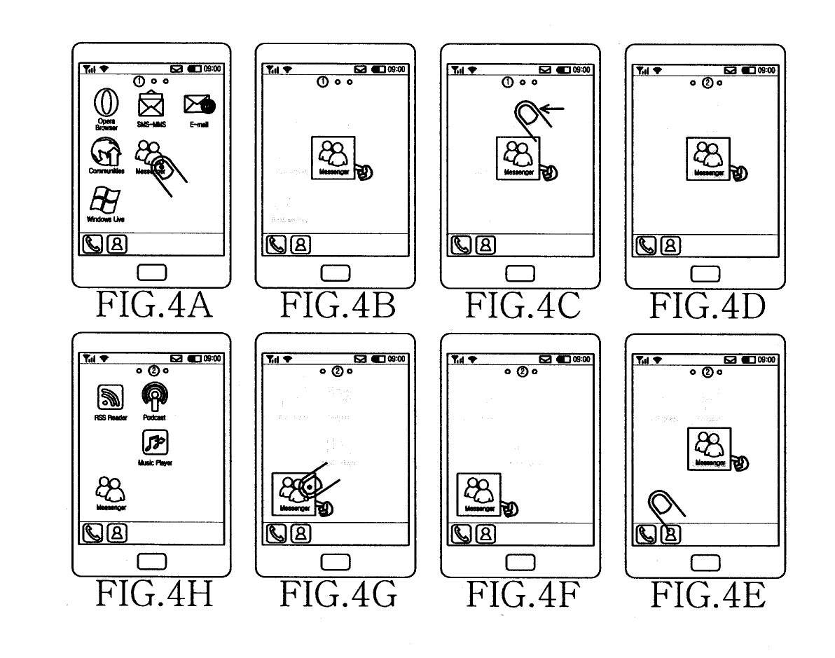

FIGS. 4A to 4H illustrate a process of arranging an icon in a touch screen terminal according to another exemplary embodiment of the present invention.

Referring to FIG. 4A, a user touches an icon to be rearranged among icons existing on a current page for more than a critical time period. Referring to FIG. 4B, the selected icon to be rearranged is highlighted, and the other icons are displayed in a disabled state. In addition, the selected icon is highlighted by displaying a hand image or other image thereto. To be specific, an index finger image is additionally displayed on the selected icon. Referring to FIG. 4C, if the user wants to rearrange the selected icon to a next page, the user performs the touch flicking motion to a desired direction. Referring to FIG. 4D, the page is switched by the touch flicking Here, icons existing on the switched page are displayed according to a disabled state, and the highlighted icon selected on the previous page is moved to and displayed on a predetermined location of the switched page.

Referring to FIGS. 4E and 4F, if the user touches a specific position on the switched page, the selected icon is displayed at the touched position. Further, the user may determine a new target position while moving the selected icon on the switched page. Referring to FIG. 4G, if the user touches the selected icon or presses the home button after finishing moving the selected icon, the rearrangement of the selected icon is completed, the added hand image is removed, and the other icons are redisplayed in an enabled state as shown in FIG. 4H.

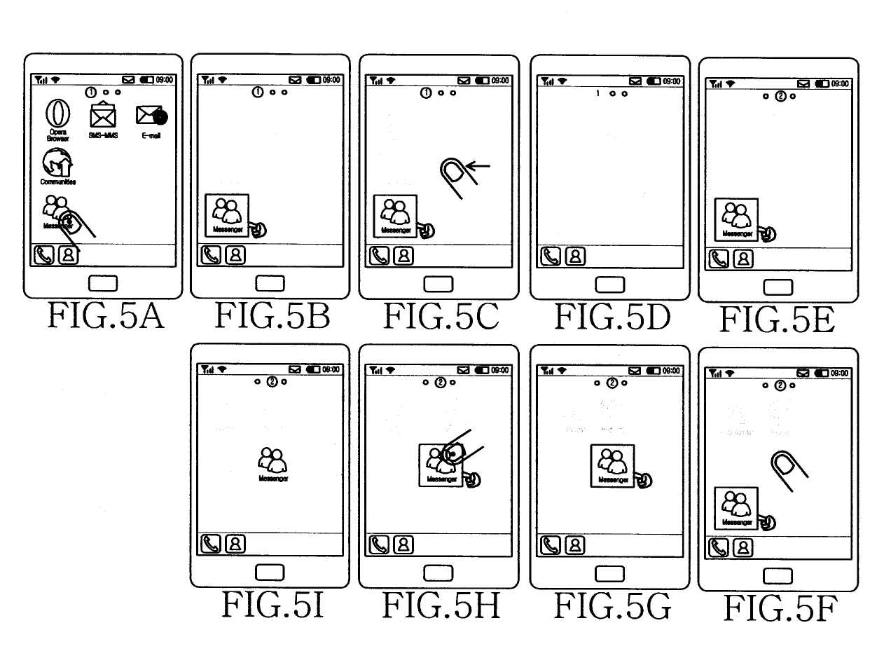

FIGS. 5A to 5I illustrate a process of arranging an icon in a touch screen terminal according to another exemplary embodiment of the present invention.

Referring to FIG. 5A, a user touches an icon to be rearranged among icons existing on a current page for more than a critical time period. Referring to FIG. 5B, the selected icon to be rearranged is highlighted, and the other icons are displayed in a disabled state. In addition, the selected icon is highlighted by displaying a hand image or other image thereto. To be specific, an index finger image is additionally displayed on the selected icon. Referring to FIG. 5C, if the user wants to rearrange the selected icon to a next page, the user performs the touch flicking motion to a desired direction. Referring to FIGS. 5D and 5E, the page is switched by the touch flicking, and the selected icon is moved to the switched page with an action of picking up the icon with a hand. As described above, this gives interest and intimacy to the user. Icons existing on the switched page are displayed according to a disabled state, and the highlighted icon selected on the previous page is moved to and displayed on a predetermined location of the switched page. In some cases, as illustrated, the selected icon may be displayed to over with a specific icon existing on the switch page. Referring to FIGS. 5F and 5G, if the user touches a specific position on the switched page, the selected icon is displayed at the touched position. Further, the user may determine a new target position while moving the selected icon on the switched page. Referring to FIG. 5H, if the user touches the selected icon or presses the home button after finishing moving the selected icon, the rearrangement of the selected icon is completed, the added hand image is removed, and the other icons are redisplayed in an enabled state as shown in FIG. 5I.

In FIGS. 3 to 5, the user may finally determine the target position while moving the selected icon on the switched page. That is, the control unit 14 detects a first touch signal on a corresponding page, moves the selected icon to a position corresponding to the first touch signal, displays the selected icon at the corresponding position, and completes the arrangement of the selected icon when a second signal is detected. The second signal may be generated when the icon is touched or the home button is pressed. In addition, the first touch signal and the second signal may be generated at the same time. For example, if a specific position on the corresponding page is touched for more than a critical time, the selected icon may be immediately arranged at the touched position.

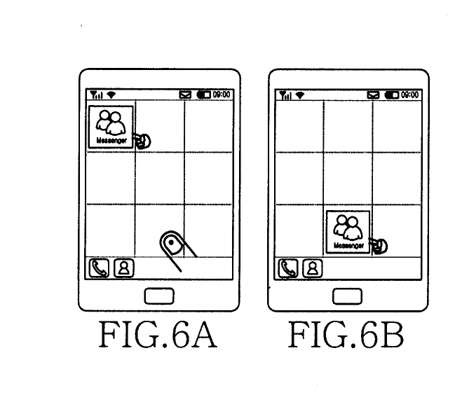

FIGS. 6A and 6B illustrate a process of moving an icon on a corresponding page in a touch screen terminal according to an exemplary embodiment of the present invention

Referring to FIGS. 6A and 6B, the control unit 14 partitions the screen into a plurality of regions. If the user touches a specific position, the control unit 14 checks the region including the touched position, moves the icon to the checked region, and displays the icon in the checked region.

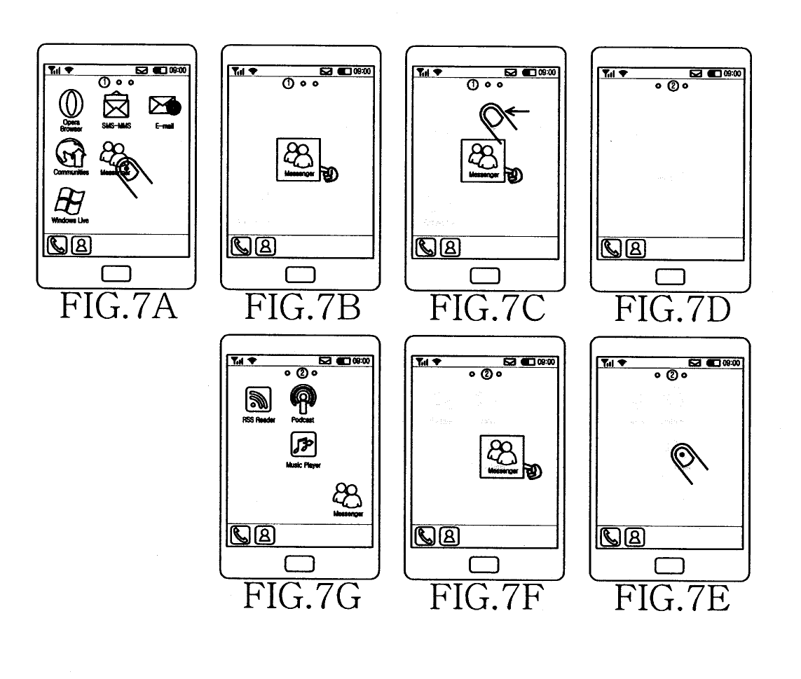

FIGS. 7A to 7G illustrate a process of arranging an icon in a touch screen terminal according to an exemplary embodiment of the present invention.

Referring to FIG. 7A, a user touches an icon to be rearranged among icons existing on a current page for more than a critical time period. Referring to FIG. 7B, the selected icon to be rearranged is highlighted, and the other icons are displayed according to a disabled state, where unselected icons is not shown or may be shown in different shade or color. In addition, the selected icon is highlighted by adding a hand image or other image thereto. To be specific, an index finger image is additionally displayed on the selected icon. Referring to FIG. 7C, if the user wants to rearrange the selected icon to a next page, the user performs the touch flicking to a desired direction. Referring to FIG. 7D, the page is switched in response to the touch flicking. In this case, icons existing on the switched page are displayed according to a disabled state. Referring to FIG. 7E, the user keeps touching a region where other icon of the corresponding page is located for more than a critical time period. Referring to FIG. 7F, the control unit 14 may display the target icon to overlap with other icon. Referring to FIG. 7G, the control unit 14 arranges a target icon in an empty.

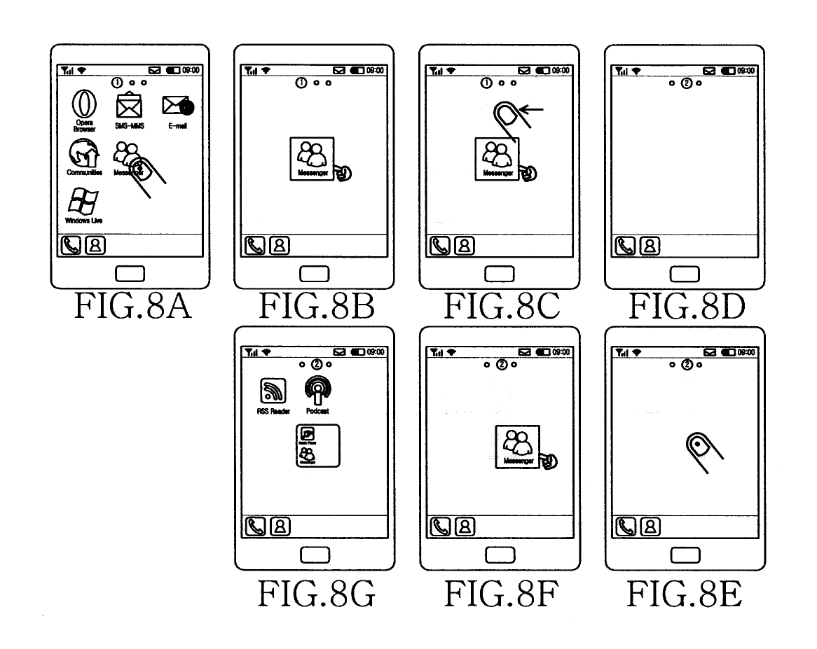

FIGS. 8A to 8G illustrate a process of arranging an icon in a touch screen terminal according to an exemplary embodiment of the present invention.

Referring to FIG. 8A, a user touches an icon to be rearranged among icons existing on a current page for more than a critical time period. Referring to FIG. 8B, the selected icon to be rearranged is highlighted, and the other icons are displayed according to a disabled state, where unselected icons is not shown or may be shown in different shade or color. In addition, the selected icon is highlighted by adding a hand image or other image thereto. To be specific, an index finger image is additionally displayed on the selected icon. Referring to FIG. 8C, if the user wants to rearrange the selected icon to a next page, the user performs the touch flicking to a desired direction. Referring to FIG. 8D, the page is switched in response to the touch flicking In this case, icons existing on the switched page are displayed according to a disabled state. Referring to FIG. 8E, the user keeps touching a region where other icon of the corresponding page is located for more than a critical time period. Referring to FIG. 8F, the control unit 14 may display the target icon to overlap with the other icon. Referring to FIG. 8G, the control unit 14 generates a folder including the target icon and the other icon and displays the folder in replacement of the other icon.

The apparatus and method for arranging an icon in touch screen terminal according to the exemplary embodiments of the present invention may rearrange an icon through a simple touch and give interest and intimacy to the user by adding a visual effect as if an icon to be rearranged is picked up and moved during transition between pages.

It will be appreciated that embodiments of the present invention according to the claims and description in the specification can be realized in the form of hardware, software or a combination of hardware and software. Any such software may be stored in a computer readable storage medium. The computer readable storage medium stores one or more programs (software modules), the one or more programs comprising instructions, which when executed by one or more processors in an electronic device, cause the electronic device to perform a method of the present invention. Further, any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for arranging an icon in a touch screen terminal, comprising:
selecting an icon and displaying another image next to the selected icon on a first menu screen;
designating a position on a second menu screen; and
arranging the selected icon at the designated position of the second menu screen.

2. The method of claim 1, further comprising highlighting the selected icon.

3. The method of claim 2, wherein the highlighting of the selected icon comprises any one process of:
additionally displaying a hand image of indicating or picking up the selected icon;
blurring regions other than a region where the selected icon is displayed;
displaying other icons in a disabled state; and
displaying icons other than the selected icon in a disabled state.

4. The method of claim 1, wherein the icon is selected if a specific touch signal generated from the corresponding icon is detected.

5. The method of claim 1, wherein the designating the position comprises:
detecting a first touch signal generated from a corresponding position on a displayed page; and
designating a position corresponding to the first touch signal if a second signal is detected.

6. The method of claim 5, wherein the arranging of the selected icon at the designated position comprises:
moving the selected icon to the position corresponding to the first touch signal and displaying the selected icon at the corresponding position; and
completing the arrangement of the selected icon if the second signal is detected.

7. The method of claim 6, wherein the first touch signal and the second signal are generated at the same time.

8. The method of claim 1, wherein the designating the position comprises:
detecting a page switching signal;
switching to a previous or next page; and
selecting the switched page.

9. The method of claim 8, further comprising moving the selected icon to the switched page and displaying the selected icon on the switched page.

10. The method of claim 1, wherein the arranging of the selected icon at the designated position is performed by any one step of:
if the designated position belongs to a region where other icon is displayed, generating a folder including the two icons and arranging the folder in replacement of the other icon;
if the designated position belongs to a region where other icon is displayed, arranging the selected in an empty region adjacent to the other icon; and
partitioning a screen into a plurality of regions and arranging the selected icon in a region to which the designated position belongs.

11. An apparatus for arranging an icon in a touch screen terminal, comprising:
a touch screen unit for inputting and outputting data; and
a control unit for selecting a target icon on a first menu screen according to a signal selecting an icon to be rearranged, displaying another image next to the selected target icon on the first menu screen, designating a target position according to a signal designating a position where the selected icon is to be rearranged on a second menu screen, and arranging the selected icon at the designated position on the second menu screen.

12. The apparatus of claim 11, wherein the control unit highlights the selected icon.

13. The apparatus of claim 12, wherein the control unit performs any one step of:
additionally displaying a hand image of indicating or picking up the selected icon;
blurring regions other than a region where the selected icon is displayed;
displaying other icons in a disabled state; and
displaying icons other than the selected icon in a disabled state.

14. The apparatus of claim 11, wherein the control unit selects the icon if a specific touch signal generated from the corresponding icon is detected.

15. The apparatus of claim 11, wherein the control unit detects a first touch signal generated from the corresponding position on a displayed page, and designates a position corresponding to the first touch signal if a second signal is detected.

16. The apparatus of claim 15, wherein the control unit moves the selected icon to the position corresponding to the first touch signal, displays the selected icon at the corresponding position, and completes the arrangement of the selected icon if the second signal is detected.

17. The apparatus of claim 16, wherein the first touch signal and the second signal are generated at the same time.

18. The apparatus of claim 11, wherein the control unit detects a page switching signal, switches to a previous or next page, and selects the switched page.

19. The apparatus of claim 18, wherein the control unit moves the selected icon to the switched page and displays the selected icon on the switched page.

20. The apparatus of claim 11, wherein the control unit performs any one step of:
if the designated position belongs to a region where other icon is displayed, generating a folder including the two icons and arranging the folder in replacement of the other icon;
if the designated position belongs to a region where other icon is displayed, arranging the selected in an empty region adjacent to the other icon; and
partitioning a screen into a plurality of regions and arranging the selected icon in a region to which the designated position belongs.
